(19) United States
(12) Patent Application Publication
(10) Pub. No.: US 2024/0400107 A1
(43) Pub. Date: Dec. 5, 2024

(54) VEHICLE TASK MANAGER

(71) Applicant: INTERNATIONAL BUSINESS MACHINES CORPORATION, ARMONK, NY (US)

(72) Inventors: Siddhartha Sood, Ghaziabad (IN); Jasbir Singh Dhaliwal, Noida (IN); Abhishek Jain, Baraut (IN)

(21) Appl. No.: 18/325,159

(22) Filed: May 30, 2023

(51) Int. Cl. B60W 60/00; B60H 1/00

(52) U.S. Cl. CPC B60W 60/00256; B60H 1/00007

(57) ABSTRACT

A method for managing tasks performable by autonomous vehicles includes performing a setup for various utility capabilities of an autonomous vehicle, where the various utility capabilities of the autonomous vehicles perform multiple activities to complete a task. The method also includes receiving programming constructs to support task definitions and configurations of the various utility capabilities of the autonomous vehicle. The method also includes configuring the autonomous vehicle with the multiple activities to complete the task and associating each activity with one or more utility capabilities from the various utility capabilities of the autonomous vehicle. The method also includes instructing the autonomous vehicle to perform the multiple activities to complete the task and validating, via the various utility capabilities of the autonomous vehicle, the completion of the task.

### BACKGROUND

This disclosure relates generally to autonomous vehicles, and in particular to managing tasks performable by autonomous vehicles.

Presently, vehicles are deploying various levels of autonomous driving with the intention of eventually reaching a level of full autonomy, where an owner of the vehicle would no longer require providing input and/or monitor operations of the vehicle. The level of full autonomy would allow for the owner of the vehicle to be driven to various locations in a manner similar to the owner driving the vehicle themselves to the various locations. With the constantly expanding technology in the objective to achieve the level of full autonomy for vehicles, the capabilities of the vehicle extend beyond just being able to drive the owner of the vehicle between point A and point B. The expanding technology allows for the autonomous vehicle to perform tasks outside of the typical capabilities of a non-autonomous or semi-autonomous vehicle.

### SUMMARY

Embodiments in accordance with the present invention disclose a method, computer program product and computer system for managing tasks performable by autonomous vehicles, the method, computer program product and computer system can perform a setup for a plurality of utility capabilities of an autonomous vehicle, wherein the plurality of utility capabilities of the autonomous vehicles performs a plurality of activities to complete a task. The method, computer program product and computer system can receive programming constructs to support task definitions and configurations of the plurality of utility capabilities of the autonomous vehicle. The method, computer program product and computer system can configure the autonomous vehicle with the plurality of activities to complete the task. The method, computer program product and computer system can associate each activity from the plurality of activities to complete the task with one or more utility capability from the plurality of utility capabilities of the autonomous vehicle. The method, computer program product and computer system can instruct the autonomous vehicle to perform the plurality of activities to complete the task. The method, computer program product and computer system can validate, via the plurality of utility capabilities of the autonomous vehicle, task completion.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a flowchart of a vehicle task manager for handling tasks performable by an autonomous vehicle, in accordance with an embodiment of the present invention.

FIG. 3 depicts a top view of an autonomous vehicle with a short-range communication reader and multiple cameras controllable by a vehicle task manager for handling tasks performable by the autonomous vehicle, in accordance with an embodiment of the present invention.

FIG. 4 depicts a top view of an autonomous vehicle with multiple short-range communication readers associated with multiple compartments controllable by a vehicle task manager for handling tasks performable by the autonomous vehicle, in accordance with an embodiment of the present invention.

FIG. 5 depicts a top view of an autonomous vehicle with external communication capabilities controllable by a vehicle task manager for handling tasks performable by the autonomous vehicle, in accordance with an embodiment of the present invention.

FIG. 6 depicts a top view of an autonomous vehicle with multiple visual indicators associated with multiple compartments controllable by a vehicle task manager for handling tasks performable by the autonomous vehicle, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention provide a vehicle task manager for handling tasks performable by autonomous vehicles, where the tasks are outside of a typical transportation of individuals between various locations. The vehicle task manager can receive, from an autonomous vehicle manufacturer, utility capabilities for a specific autonomous vehicle and can match the utility capabilities to activities associated with performing a task. The task can include an autonomous vehicle collecting an order from a retail location and delivering the order to a recipient location or an autonomous vehicle traveling to a charging station or petrol station to recharge or refuel and returning to a location associated with an owner of the autonomous vehicle. The vehicle task manager can utilize programming constructs (e.g., audio based, visual based) to allow an owner of the autonomous vehicle to interactively describe and provide details surrounding activities for performing the task. The vehicle task manager can breakdown the task into activities performable by the autonomous vehicle, whether the activities are performable sequentially or in parallel. The vehicle task manager maps the activities for the task to the utility capabilities of the autonomous vehicle to ensure the activities are performable to complete the task.

The vehicle task manager can provide feedback and/or instructions via one or more indicators which performing each activity of the task to ensure that correct utility capability (e.g., cooled storage compartment versus heated storage compartment) of the autonomous vehicle is leveraged. The vehicle task manager can suspend or abandoned a task if one or more activities were not performable by the autonomous vehicle and can provide feedback to the user and/or owner from where the task originated. The vehicle task manager can utilize iterative learning and leverage data associated with successful and unsuccessful task completion when configuring an autonomous vehicle to perform future activities for a future task. The vehicle task manager can also detect instance of misusage of the autonomous vehicle and/or non-compliance due to a regulation violation, and instruct the autonomous vehicle to suspend and/or abandoned the current task with the detected misusage and/or non-compliance.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

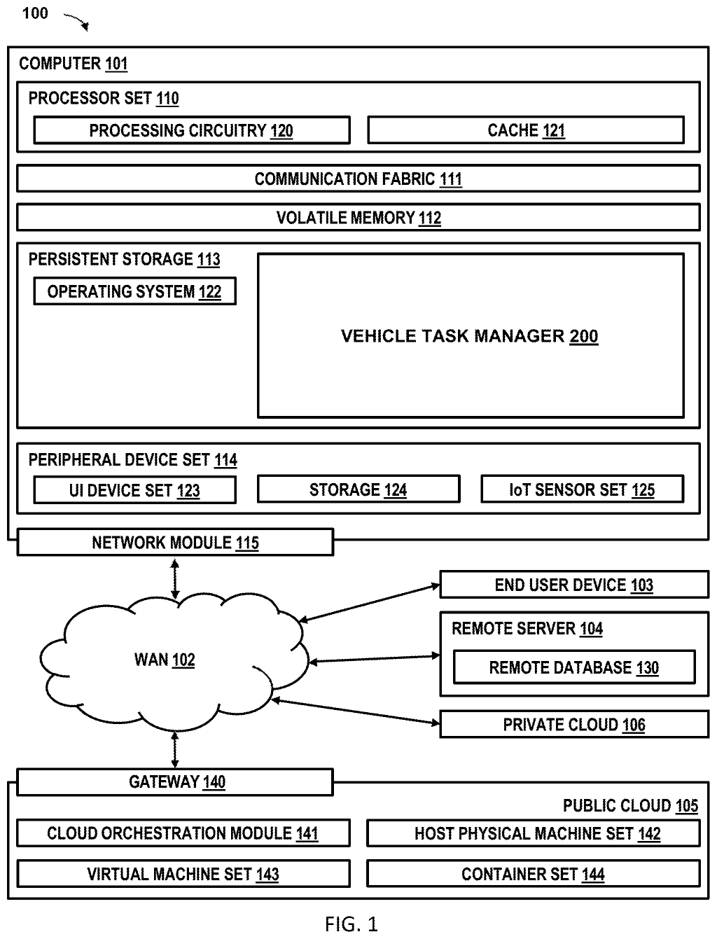

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, vehicle task manager 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

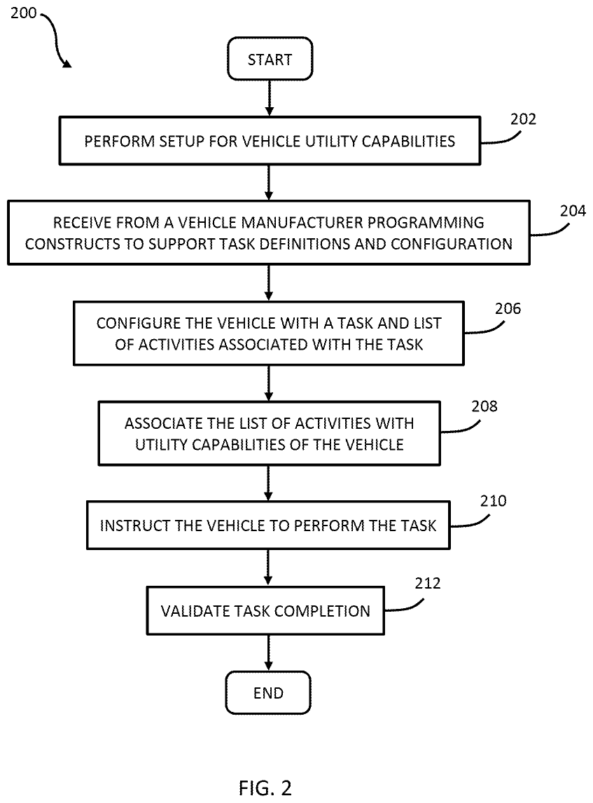

FIG. 2 depicts a flowchart of a vehicle task manager for handling tasks performable by an autonomous vehicle, in accordance with an embodiment of the present invention.

Vehicle task manager 200 performs a setup for vehicle utility capabilities (202). Vehicle task manager 200 handles tasks performable by one or more autonomous vehicles from a pool of available autonomous vehicles, depending on utility capabilities associated with each of the autonomous vehicles. Vehicle task manager 200 can query a repository that stores utility capabilities for an autonomous vehicle based on a manufacturer specification, where the utility capabilities are differentiated into two categories that include activated utility capabilities and activatable utility capabilities. Activated utility capabilities represent current features of the autonomous vehicles and can include but are not limited to various sensors, radars, cameras, actuating hardware, compartments, and autonomously performable tasks. Activatable utility capabilities represent installable or pre-installed features that are not activated on the autonomous vehicle (e.g., subscription based) and can include but are not limited to heated compartments, cooled compartments, payment processing, and autonomously performable tasks. In one example, vehicle task manager 200 queries a repository for the utility capabilities for an autonomous vehicle and determines the autonomous vehicle has the ability to perform and process payments and includes multiple adjustable storage compartments, multiple designated temperature-controlled storage compartments, a short-range signal reader, a unique identification code reader, and multiple item recognition cameras. From the utility capabilities, vehicle task manager 200 determines that the adjustable storage compartments, the multiple designated temperature-controlled storage compartments, the short-range signal reader, and the unique identification code reader are activated utility capabilities. From the utility capabilities, vehicle task manager 200 determines that the ability to perform and process payments and the multiple item recognition cameras are activatable utility capabilities, where the cameras are installed on the autonomous vehicles, but the item recognition software is not activated.

Vehicle task manager 200 can provide a programming interface construct associated with each of the utility capabilities, where vehicle task manager 200 can independently program each utility capability of the autonomous vehicle with a task or a part of a task. Vehicle task manager 200 can also provide a set of additional rules for the task or a part of the task within operational constraints (i.e., values) of the utility capabilities of the autonomous vehicle. For example, a first rule can include a payment is to never exceed $100 for a task performable by the autonomous vehicle. A second rule can include temperature values for a deliverable product measuring above 80° F. prior to the autonomous vehicle accepting the deliverable product for transfer to a compartment and subsequent deliver to a recipient. Vehicle task manager 200 also places emphasis on privacy and security for the owner of the autonomous vehicle. For example, vehicle task manager 200 requires the owner opt-in to allow for the autonomous vehicle to perform task outside of the typical point A to point B travels. Furthermore, vehicle task manager 200 allows for the owner to define limitations and rules to which tasks can and cannot be performed by the autonomous vehicles, along with when the tasks can and cannot be performed by the autonomous vehicles.

Vehicle task manager 200 receives from a vehicle manufacturer programming constructs to support task definitions and configuration (204). Similar to how vehicle task manager 200 can query a repository that stores utility capabilities for an autonomous vehicle based on a manufacturer specification, vehicle task manager 200 can query the repository to obtain the autonomous vehicle manufacturer programming constructs to support task definitions and configurations. Since each vehicle manufacturer produces a different product, even across a model range of a single vehicle manufacture, vehicle task manager 200 utilizes the repository to track the different utility capabilities and programming constructs associated with each of the different utility capabilities. Programming constructs can include but are not limited to mobile app-based drag and drop selections, voice based contextual communication, application programming interface (API) based construct, and software development kit (SDK) based constructs. Vehicle task manager 200 can utilize a suite of existing fully performable task defined by each vehicle manufacturer. For example, vehicle task manager 200 can provide an executable task such as collecting a food order #123 from restaurant A or collecting grocery order #456 from retailer B. Vehicle task manager 200 provides the ability to match and validate tasks to utility capabilities with each available autonomous vehicle from a pool of available autonomous vehicles. Vehicle task manager 200 allows for pre-defined tasks to be shared between owners of autonomous vehicles, where vehicle task manager 200 adds a new task to a task library in a repository and validates which of the available autonomous vehicles can perform the new task depending on utility capabilities required for performing the new task.

Vehicle task manager 200 configures the vehicle with a task and list of activities associated with the task (206). Utilizing the available programming constructs, vehicle task manager 200 receives a list of tasks performable by one or more autonomous vehicles, where each task has a list of activities or actions performable by one or more autonomous vehicles. Vehicle task manager 200 defines the list of tasks through a series of actions performable sequentially or in parallel by one or more autonomous vehicles and which actions are to be performed prior to another set of actions. In one example, vehicle task manager 200 receives a request to collect an order from a retailer, where the order requires a temperature-controlled environment for transporting contents of the order. Vehicle task manager 200 determines an order for the lists of tasks for an autonomous vehicle can include traveling to a first location associated with the retailer, activating a cooled compartment prior to arrival at the first location (e.g., 5 minutes prior), providing access to the cooled compartment on the autonomous vehicle, verifying the order was placed into the cooled compartment, and traveling to a second location associated with a recipient of the order. Vehicle task manager 200 also allows for owner validation of each task and the list of activities or actions associated with the task, prior to configuring the autonomous vehicle to perform the activities. Vehicle task manager 200 provides a configurable option to the owner, where the owner selects which task and/or which activities or actions from the list of activities or actions require validation prior to configuring the vehicle with the task and the listed of activities to be performed by one or more autonomous vehicles.

Vehicle task manager 200 associates the list of activities with utility capabilities of the vehicle (208). As discussed above with regards to the list of activities representing actions performed by an autonomous vehicle for a task, prior to performing the task with the list of activities, vehicle task manager 200 associates the list of activities for the task with the utility capabilities of the autonomous vehicle. In one example, vehicle task manager 200 is to deliver contents of an order from a retailer (i.e., the task) to a recipient, where the contents of the order are to be maintained at a temperature below 45° F. Vehicle task manager 200 associates an activity of accepting the contents of the order in a temperature controlled compartment on the autonomous vehicle and instructing a maximum temperature for the temperature controlled compartment on the autonomous be set to a maximum of 40° F. to the portions of the task that include delivering the contents of the order from the retailer to the recipient. In some embodiment, vehicle task manager 200 utilizes iterative learning based on previously completed task to provide recommendations on utility capabilities and can map the utility capabilities previously used to current activities for a current task. Vehicle task manager 200 utilizes iterative learning via the programming construct and trying to understand an intent of an activity (e.g., accept contents of an order) with respect to a task (e.g., deliver contents of an order) and mapping the activity to a utility capability (e.g., temperature-controlled storage compartment) of an autonomous vehicle. For both associating the list of activities with utility capabilities of the autonomous vehicle and providing recommendations through mapping of utility capabilities, vehicle task manager 200 can validate the task and activity configuration for the autonomous vehicle via a request to a user and/or owner, prior to finalizing the association of activities with the utility capability of the autonomous vehicle performing the task.

Vehicle task manager 200 instructs the vehicle to perform the task (210). In one example, vehicle task manager 200 receives a task of delivering contents of an order from a retail location to a recipient location, where a temperature of the contents of the order are to be maintained at a temperature below 45° F. In this example, a user of vehicle task manager 200 is also an owner of the autonomous vehicle for which vehicle task manager 200 performs a setup for the utility capabilities. Vehicle task manager 200 identifies the utility capabilities of the autonomous vehicle and receives programming constructs to support the task definitions and configuration of the utility capabilities for the vehicle. Vehicle task manager 200 configures the autonomous vehicle with the task and the list of activities associated with the task, where the list of activities includes relocating to the retail location, accepting the contents of the order, verifying the contents of the order, maintaining a temperature value equal to or below a 45° F. threshold value for a compartment with the contents of the order, and relocating to the recipient location. Alternatively, vehicle task manager 200 can instruct the autonomous vehicle to maintain a temperature value equal to or above a threshold value for a compartment with the contents of the order. Vehicle task manager 200 instructs the autonomous vehicle to perform the task by executing the list of activities, where vehicle task manager 200 can validate completion of one or more of the activities. In this example, vehicle task manager 200 can validate that the temperature of equal to or below 45° F. for a compartment with the contents of the order is maintained for a duration of travel between the retail location and the recipient location. Vehicle task manager 200 can also validate whether or not the contents of the order were placed into the autonomous vehicle for delivery to the recipient location. In other embodiments, vehicle task manager 200 can validate financial charges and perform payment processing prior to completing a task to ensure the cost of the task and/or the contents of the order are properly accounted for.

Vehicle task manager 200 validates the task completion (212). As previously discussed, vehicle task manager 200 monitors progress of the task by monitoring activity progress and execution. Vehicle task manager 200 can validate if one or more activities are completed prior to another activity being performed for the execution to ensure successful completion of the task. Vehicle task manager 200 can trigger and manage approval flow for particular activities, for example, particular activities that include payment handling and receiving of contents for an order to ensure there is evidence of completion of the particular activities for the task. Certain activities can include regulatory requirements, where vehicle task manager 200 confirms that a regulatory requirement is met for an activity prior to validating a task. For example, vehicle task manager 200 instructs an autonomous vehicle to collect a prescription medicine order from a pharmacy location and delivery the prescription medicine order to a recipient location, vehicle task manager 200 cannot validate the prescription medicine order unless a prescription document matching the prescription medicine order is present. Vehicle task manager 200 can also perform misusage checks of the autonomous vehicle for a task that can require a specific vehicle type and/or vehicle registration. For example, vehicle task manager 200 can perform a misusage check to see if a personal autonomous vehicle is being utilized in a commercial, rideshare, and/or ride for hire manner when deemed inappropriate for the task and operational geographical location.

Vehicle task manager 200 utilizes iterative learning by leveraging previously completed tasks and activities data to assist in future configurations of the autonomous vehicle with task and list of activities associated with the task, where a likelihood of user and/or owner intervention decreases and successful task completion validation increases. Vehicle task manager 200 can leverage the previously completed tasks and activities to provide recommendations, as previously discussed, of utilities for one or more activities associated with a task. Vehicle task manager 200 can leverage the previously completed tasks and activities to provide time estimates for completion of activities associated with a task and to determine when to initiate user and/or owner approvals prior to proceeding with task performable by the autonomous vehicle.

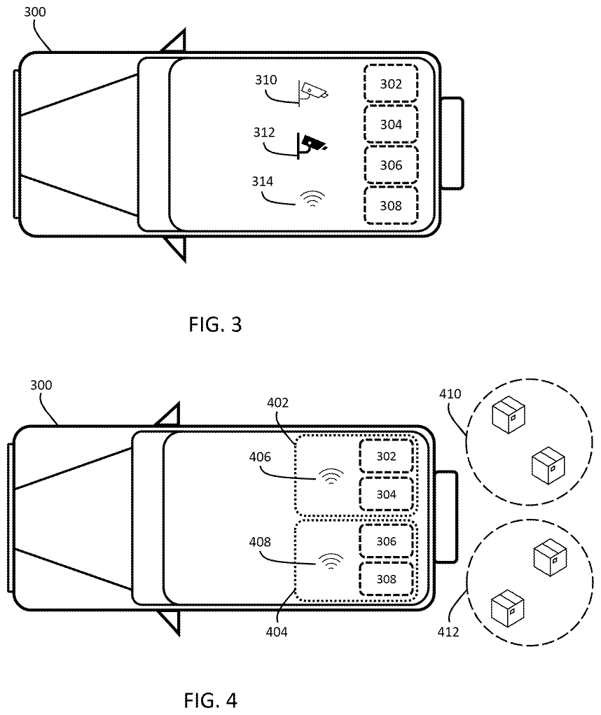

FIG. 3 depicts a top view of an autonomous vehicle with a short-range communication reader and multiple cameras controllable by a vehicle task manager for handling tasks performable by the autonomous vehicle, in accordance with an embodiment of the present invention. In this example, vehicle task manager 200 receives multiple tasks of delivering the contents of multiples orders from various retail locations to multiple recipient locations. Autonomous vehicle 300 includes compartment 302, 304, 306, and 308 for transporting the contents of the multiple orders from the various locations, two-dimensional camera 310, three-dimensional camera 312, and short-range communications reader 314. As autonomous vehicle 300 approaches a first retail location, vehicle task manager 200 can assign a designated compartment based on the task and utility capabilities of each of compartments 302, 304, 306, and 308. For example, compartments 302, 304, 306, and 308 are each of varying dimensions and vehicle task manager 200 can assign a specific compartment (e.g., compartment 304) based on the contents of an order associated with the task. The combination of two-dimensional camera 310 and three-dimensional camera 312 can provide validation to vehicle task manager 200 that the contents for an order were placed in the specific compartment and short-range communication reader 314 can validate the content themselves prior to instructing autonomous vehicle 300 to relocate to a delivery address (i.e., recipient location). Though not illustrated in FIG. 3, in some embodiments autonomous vehicle 300 can include an integrated scale in each of compartments 302, 304, 306, and 308 to weigh the contents and send a weight value (e.g., 7 lbs., 6 oz.) to vehicle task manager 200 to validate that the weight value matches an expected weight value for the contents of the order associated with the task. Additionally, in some embodiment autonomous vehicle 300 can include an expandable opening to each of compartments 302 304, 306, and 308, where vehicle task manager 200 provides dimensions for the expanding openings for each compartment 302, 304, 306, and 308 to autonomous vehicle 300 depending on dimensions of the contents being placed within each of each compartment 302, 304, 306, and 308.

FIG. 4 depicts a top view of an autonomous vehicle with multiple short-range communication readers associated with multiple compartments controllable by a vehicle task manager for handling tasks performable by the autonomous vehicle, in accordance with an embodiment of the present invention. In this example, vehicle task manager 200 receives multiple tasks of delivering the contents of multiples orders from various retail locations to multiple recipient locations, where a portion of the multiple orders are to be kept at a temperature above 80° F. and a remaining portion of the multiple orders are to be kept at a temperature below 45° F. Autonomous vehicle 300 includes temperature controlled compartments 302, 304, 306, and 308, where vehicle task manager 200 identifies utility capabilities of autonomous vehicle 300. Vehicle task manager 200 designates group 402 with compartments 302 and 304 as heated compartments and group 404 with compartments 306 and 308 as cooled compartments, where short-communication range reader 406 is assigned to group 402 and short-range communication reader 408 to group 404. Based on the multiple tasks and utility capabilities of autonomous vehicle 300, vehicle task manager 200 assigns packages 410 to group 402 with the heated compartments to maintain a temperature above 80° F. and assigns packages 412 to group 404 with the cooled compartment to maintain a temperature below 45° F.

FIG. 5 depicts a top view of an autonomous vehicle with external communication capabilities controllable by a vehicle task manager for handling tasks performable by the autonomous vehicle, in accordance with an embodiment of the present invention. In this example, for each of compartments 302, 304, 306, and 308, vehicle task manager 200 can receive storage conditions and weight values for storage in a centralized server 502. Vehicle task manager 200 associates the storage conditions and weight values with activities associated with each task for iterative learning. As previously discussed, vehicle task manager 200 can leverage the previously completed tasks and activities to provide recommendations of utilities of autonomous vehicle 300 for one or more activities associated with a future task.

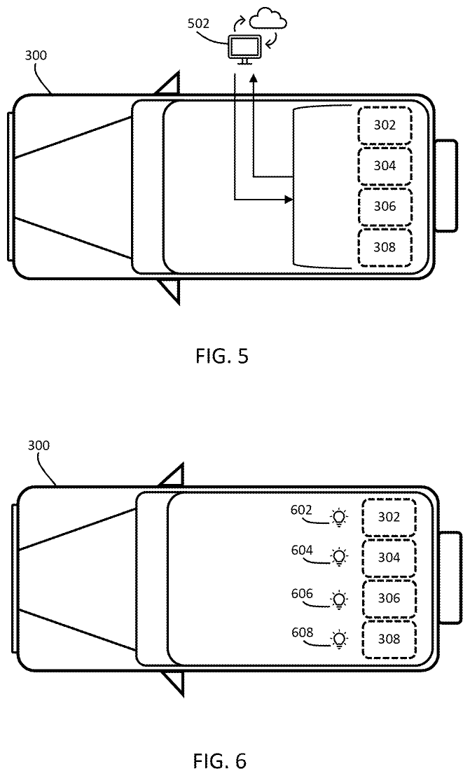

FIG. 6 depicts a top view of an autonomous vehicle with multiple visual indicators associated with multiple compartments controllable by a vehicle task manager for handling tasks performable by the autonomous vehicle, in accordance with an embodiment of the present invention. In this example, autonomous vehicle 300 includes visual indicators 602, 604, 606, and 608 associated with compartments 302, 304, 306, and 308, respectively. Vehicle task manager 200 can activate the visual indicators to instruct where contents of an order to be placed at a retail location and collected at a recipient location. Visual indicators 602, 604, 606, and 608 represent an example of utility capabilities of autonomous vehicle 300 of which vehicle task manager 200 can configure and control to perform one or more activities to complete a task.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
performing a setup for a plurality of utility capabilities of an autonomous vehicle, wherein the plurality of utility capabilities of the autonomous vehicles performs a plurality of activities to complete a task;
receiving programming constructs to support task definitions and configurations of the plurality of utility capabilities of the autonomous vehicle;
configuring the autonomous vehicle with the plurality of activities to complete the task;
associating each activity from the plurality of activities to complete the task with one or more utility capabilities from the plurality of utility capabilities of the autonomous vehicle;
instructing the autonomous vehicle to perform the plurality of activities to complete the task; and
validating, via the plurality of utility capabilities of the autonomous vehicle, task completion.

2. The computer-implemented method of claim 1, wherein performing a setup for the plurality of utility capabilities of the autonomous vehicle further comprises:
querying a repository for the plurality of utility capabilities of the autonomous vehicle based on a manufacturer specification;
determining a first portion of the plurality of utility capabilities of the autonomous vehicle include activated utility capabilities and a second portion of the plurality of utility capabilities of the autonomous vehicle include activatable utility capabilities; and
providing at least one rule for at least one utility capability from the plurality of utility capabilities of the autonomous vehicles that performs the plurality of activities to complete the task.

3. The computer-implemented method of claim 1, wherein the activated utility capabilities are selected from the group consisting of: sensors, radars, cameras, actuating hardware, compartments, and autonomously performable tasks.

4. The computer-implemented method of claim 1, wherein the activatable utility capabilities are selected from the group consisting of: heated compartments, cooled compartments, payment processing, and autonomously performable tasks.

5. The computer-implemented method of claim 1, wherein instructing the autonomous vehicle to perform the plurality of activities to complete the task further comprises:
instructing the autonomous vehicle to relocate to a retail location;
responsive to the autonomous vehicle relocating to the retail location, accepting contents associated with an order at the retail location;
verifying the contents associated with the order; and
instructing the autonomous vehicle to relocate to a recipient location associated with the order.

6. The computer-implemented method of claim 5, further comprising:
instructing the autonomous vehicle to maintain a temperature value equal to or above a temperature threshold value for a compartment with the contents associated with the order.

7. The computer-implemented method of claim 5, further comprising:
instructing the autonomous vehicle to maintain a temperature value equal to or below a temperature threshold value for a compartment with the contents associated with the order.

8. A computer program product comprising:
one or more computer-readable storage media;
program instructions, stored on at least one of the one or more storage media, to perform a setup for a plurality of utility capabilities of an autonomous vehicle, wherein the plurality of utility capabilities of the autonomous vehicles performs a plurality of activities to complete a task;
program instructions, stored on at least one of the one or more storage media, to receive programming constructs to support task definitions and configurations of the plurality of utility capabilities of the autonomous vehicle;
program instructions, stored on at least one of the one or more storage media, to configure the autonomous vehicle with the plurality of activities to complete the task;
program instructions, stored on at least one of the one or more storage media, to associate each activity from the plurality of activities to complete the task with one or more utility capabilities from the plurality of utility capabilities of the autonomous vehicle;
program instructions, stored on at least one of the one or more storage media, to instruct the autonomous vehicle to perform the plurality of activities to complete the task; and
program instructions, stored on at least one of the one or more storage media, to validate, via the plurality of utility capabilities of the autonomous vehicle, task completion.

9. The computer program product of claim 8, wherein program instructions, stored on at least one of the one or more storage media, to perform a setup for the plurality of utility capabilities of the autonomous vehicle, further comprises:
program instructions, stored on at least one of the one or more storage media, to query a repository for the plurality of utility capabilities of the autonomous vehicle based on a manufacturer specification;
program instructions, stored on at least one of the one or more storage media, to determine a first portion of the plurality of utility capabilities of the autonomous vehicle include activated utility capabilities and a second portion of the plurality of utility capabilities of the autonomous vehicle include activatable utility capabilities; and
program instructions, stored on at least one of the one or more storage media, to provide at least one rule for at least one utility capability from the plurality of utility capabilities of the autonomous vehicles that performs the plurality of activities to complete the task.

10. The computer program product of claim 8, wherein the activated utility capabilities are selected from the group consisting of: sensors, radars, cameras, actuating hardware, compartments, and autonomously performable tasks.

11. The computer program product of claim 8, wherein the activatable utility capabilities are selected from the group consisting of: heated compartments, cooled compartments, payment processing, and autonomously performable tasks.

12. The computer program product of claim 8, wherein program instructions, stored on at least one of the one or more storage media, to instruct the autonomous vehicle to perform the plurality of activities to complete the task, further comprises:
program instructions, stored on at least one of the one or more storage media, to instruct the autonomous vehicle to relocate to a retail location;
responsive to the autonomous vehicle relocating to the retail location, program instructions, stored on at least one of the one or more storage media, to accept contents associated with an order at the retail location;
program instructions, stored on at least one of the one or more storage media, to verify the contents associated with the order; and
program instructions, stored on at least one of the one or more storage media, to instruct the autonomous vehicle to relocate to a recipient location associated with the order.

13. The computer program product of claim 12, further comprising:
program instructions, stored on at least one of the one or more storage media, to instructing the autonomous vehicle to maintain a temperature value equal to or above a temperature threshold value for a compartment with the contents associated with the order.

14. The computer program product of claim 12, further comprising:
program instructions, stored on at least one of the one or more storage media, to instruct the autonomous vehicle to maintain a temperature value equal to or below a temperature threshold value for a compartment with the contents associated with the order.

15. A computer system comprising:
one or more processors, one or more computer-readable memories and one or more computer-readable storage media;
program instructions, stored on at least one of the one or more storage media for execution by at least one of the one or more processors via at least one of the one or more memories, to perform a setup for a plurality of utility capabilities of an autonomous vehicle, wherein the plurality of utility capabilities of the autonomous vehicles performs a plurality of activities to complete a task;
program instructions, stored on at least one of the one or more storage media for execution by at least one of the one or more processors via at least one of the one or more memories, to receive programming constructs to support task definitions and configurations of the plurality of utility capabilities of the autonomous vehicle;
program instructions, stored on at least one of the one or more storage media for execution by at least one of the one or more processors via at least one of the one or more memories, to configure the autonomous vehicle with the plurality of activities to complete the task;
program instructions, stored on at least one of the one or more storage media for execution by at least one of the one or more processors via at least one of the one or more memories, to associate each activity from the plurality of activities to complete the task with one or more utility capabilities from the plurality of utility capabilities of the autonomous vehicle;
program instructions, stored on at least one of the one or more storage media for execution by at least one of the one or more processors via at least one of the one or more memories, to instruct the autonomous vehicle to perform the plurality of activities to complete the task; and
program instructions, stored on at least one of the one or more storage media for execution by at least one of the one or more processors via at least one of the one or more memories, to validate, via the plurality of utility capabilities of the autonomous vehicle, task completion.

16. The computer system of claim 15, wherein program instructions, stored on at least one of the one or more storage media for execution by at least one of the one or more processors via at least one of the one or more memories, to perform a setup for the plurality of utility capabilities of the autonomous vehicle, further comprises:
program instructions, stored on at least one of the one or more storage media for execution by at least one of the one or more processors via at least one of the one or more memories, to query a repository for the plurality of utility capabilities of the autonomous vehicle based on a manufacturer specification;
program instructions, stored on at least one of the one or more storage media for execution by at least one of the one or more processors via at least one of the one or more memories, to determine a first portion of the plurality of utility capabilities of the autonomous vehicle include activated utility capabilities and a second portion of the plurality of utility capabilities of the autonomous vehicle include activatable utility capabilities; and
program instructions, stored on at least one of the one or more storage media for execution by at least one of the one or more processors via at least one of the one or more memories, to provide at least one rule for at least one utility capability from the plurality of utility capabilities of the autonomous vehicles that performs the plurality of activities to complete the task.

17. The computer system of claim 15, wherein the activated utility capabilities are selected from the group consisting of: sensors, radars, cameras, actuating hardware, compartments, and autonomously performable tasks.

18. The computer system of claim 16, wherein the activatable utility capabilities are selected from the group consisting of: heated compartments, cooled compartments, payment processing, and autonomously performable tasks.

19. The computer system of claim 15, wherein program instructions, stored on at least one of the one or more storage media for execution by at least one of the one or more processors via at least one of the one or more memories, to instruct the autonomous vehicle to perform the plurality of activities to complete the task, further comprises:
program instructions, stored on at least one of the one or more storage media for execution by at least one of the one or more processors via at least one of the one or more memories, to instruct the autonomous vehicle to relocate to a retail location;
responsive to the autonomous vehicle relocating to the retail location, program instructions, stored on at least one of the one or more storage media for execution by at least one of the one or more processors via at least one of the one or more memories, to accept contents associated with an order at the retail location;
program instructions, stored on at least one of the one or more storage media for execution by at least one of the one or more processors via at least one of the one or more memories, to verify the contents associated with the order; and
program instructions, stored on at least one of the one or more storage media for execution by at least one of the one or more processors via at least one of the one or more memories, to instruct the autonomous vehicle to relocate to a recipient location associated with the order.

20. The computer system of claim 15, further comprising:
program instructions, stored on at least one of the one or more storage media for execution by at least one of the one or more processors via at least one of the one or more memories, to instruct the autonomous vehicle to maintain a temperature value equal to or above a temperature threshold value for a compartment with the contents associated with the order.
